(19) United States
(12) Patent Application Publication
(10) Pub. No.: US 2019/0146294 A1
(43) Pub. Date: May 16, 2019

(54) ELECTROCHROMIC ELECTRODES AND METHODS OF MAKING AND USE THEREOF

(71) Applicant: BOARD OF REGENTS, THE UNIVERSITY OF TEXAS SYSTEM, Austin, TX (US)

(72) Inventors: Delia Milliron, Austin, TX (US); Jongwook Kim, Austin, TX (US)

(21) Appl. No.: 16/096,418

(22) PCT Filed: Apr. 28, 2017
(86) PCT No.: PCT/US17/30108

§ 371 Date: Oct. 25, 2018

Related U.S. Application Data
(60) Provisional application No. 62/328,755, filed on Apr. 28, 2016.

(51) Int. Cl. G02F 1/155; G02F 1/153; G02F 1/1524

(52) U.S. Cl. CPC G02F 1/155; G02F 2001/1555; G02F 1/1524; G02F 1/1533

(57) ABSTRACT

Disclosed herein are electrochromic electrodes. The electrochromic electrodes can comprise a conducting layer; an electrochromic layer; and a conformal hole blocking layer; wherein the electrochromic layer is disposed between the conducting layer and the hole blocking layer such that the electrochromic layer is in electrical contact with the conducting layer and the hole blocking layer. The electrochromic electrodes disclosed herein can exhibit improved properties compared to an electrode comprising the same conducting layer and electrochromic layer but without the conformal hole blocking layer. For example, the electrochromic electrodes can have a reduced photochromic effect as compared to an electrode comprising the same conducting layer and electrochromic layer but without the conformal hole blocking layer. Methods of making and methods of use of the electrochromic electrodes are also discussed.

### CROSS-REFERENCE TO RELATED APPLICATIONS

This application claims the benefit of U.S. Provisional Application No. 62/328,755, filed Apr. 28, 2016, which is hereby incorporated herein by reference in its entirety.

### STATEMENT OF GOVERNMENT SUPPORT

This invention was made with government support under Grant No. DE-AR0000489 awarded by the Department of Energy. The government has certain rights in this invention.

### BACKGROUND

Electrochromic films undergo changes to their optical properties under electrochemical bias providing optical contrast on demand. The applied electrochemical bias to causes electrochemical redox reactions in electrochromic materials, resulting in the change in optical properties. The switching between different optical states upon the application of an electrochemical bias should be fast and reversible for at least thousands of cycles. Transition metal oxides are a large family of materials possessing various interesting properties in the field of electrochromism.

A large portion of the world's energy expenditure is devoted to the heating, cooling and lighting of buildings. As the color change is persistent and energy need only be applied to effect a change, electrochromic materials can be used to control the amount of light and heat allowed to pass through windows (e.g., “smart windows”), though other industrial applications for electrochromic materials include optical filters and displays.

However, some types of external stimulus (e.g., UV light) can also unintentionally and irreversibly change the optical contrast, which can seriously disturb an efficient electrochromic control. For example, UV-darkening disturbs controlling the device transmittance in this way and also degrades both the electrochromic layer and electrolyte, which can ultimately make the switching irreversible. The compositions and methods discussed herein address these and other needs.

### SUMMARY

Disclosed herein are electrochromic electrodes. The electrochromic electrodes can comprise a conducting layer; an electrochromic layer; and a conformal hole blocking layer; wherein the electrochromic layer is disposed between the conducting layer and the hole blocking layer such that the electrochromic layer is in electrical contact with the conducting layer and the hole blocking layer.

In some examples, the electrochromic electrodes can have an average transmittance of 50% or more at one or more wavelengths from 400 nm to 2200 nm after irradiation with UV light for 3 hours or more. In some examples, the electrochromic electrodes can have a first optical state and a second optical state, wherein each of the first optical state and the second optical state has an average transmittance at one or more wavelengths from 400 nm to 2200 nm, wherein the average transmittance of the second optical state is less than the average transmittance of the first optical state by 20% or more at one or more wavelengths from 400 nm to 2200 nm, and wherein the electrochromic electrode can be switched from the first optical state to the second optical state and/or from the second optical state to the first optical state upon application of a potential to the electrochromic electrode. In some examples, the electrochromic electrode can have a charge capacity that decreases by 5% or less after 200 cycles or more. In some examples, the electrochromic electrodes can have an average absorbance at one or more wavelengths from 400 nm to 2200 nm that decreases by 5% or less after 200 cycles or more.

In some examples, hole blocking layer can comprise a metal oxide. The hole blocking layer can, for example, comprise a metal oxide where the metal is selected from Al, Hf, Nb, Ta, and combinations thereof. In some examples, the hole blocking layer can comprise Ta₂O₅, Al₂O₃, Nb₂O₅, HfO₂, or combinations thereof. The average thickness of the hole blocking layer can be, for example, from 0.5 nm to 10 nm (e.g., from 1 nm to 5 nm).

In some examples, the electrochromic layer can comprise a metal oxide. In some examples, the electrochromic layer can comprise a metal oxide where the metal is selected from the group consisting of Cr, Co, Mn, Mo, Nb, Ni, Ti, V, W, and combinations thereof. In some examples, the electrochromic layer can comprise WO₃, MoO₃, V₂O₅, Nb₂O₅, TiO₂, Cr₂O₃, MnO₂, CoO, NiO, or combinations thereof.

In some examples, the electrochromic layer can comprise a plurality of nanocrystals, a plurality of nanoparticles, or a combination thereof. The plurality of nanocrystals, the plurality of nanoparticles, or a combination thereof can have an average particle size of from 1 nm to 1000 nm.

In some examples, the conducting layer can comprise a transparent conducting oxide, a carbon material, a nanostructured metal, or a combination thereof. In some examples, the conducting layer can comprise a transparent conducting oxide. In some examples, the conducting layer can comprise a metal oxide. The metal oxide can, for example, comprise a metal selected from the group consisting of Cd, Cr, Cu, Ga, In, Ni, Sn, Ti, W, Zn, and combinations thereof. In some examples, the conducting layer can comprise, CdO, CdIn₂O₄, Cd₂SnO₄, Cr₂O₃, CuCrO₂, CuO₂, Ga₂O₃, In₂O₃, NiO, SnO₂, TiO₂, ZnGa₂O₄, ZnO, InZnO, InGaZnO, InGaO, ZnSnO, Zn₂SnO₄, CdSnO, WO₃, or combinations thereof.

Also described herein are methods of making the electrochromic electrodes described herein. For example, also disclosed herein are methods of making the electrochromic electrodes described herein, the method comprising: providing a precursor electrode, the precursor electrode comprising the conducting layer and the electrochromic layer; and depositing the hole blocking layer conformally on the electrochromic layer of the precursor electrode; thereby forming the electrochromic electrode.

Conformally depositing the hole blocking layer can, for example, comprise atomic layer deposition, chemical vapor deposition, electron beam evaporation, thermal evaporation, sputtering deposition, pulsed laser deposition, or combinations thereof. In some examples, conformally depositing the hole blocking layer comprises electrodeposition. Electrodeposition of the hole blocking layer can, for example, comprise: contacting the precursor electrode with a solution comprising a hole blocking layer precursor; and applying a potential to the precursor electrode while it is in contact with the solution, thereby depositing the hole blocking layer on the precursor electrode.

In some examples, the methods can further comprise forming the precursor electrode. Forming the precursor electrode can comprise, for example, dispersing a plurality of nanocrystals, a plurality of nanoparticles, or a combination thereof in a solution, thereby forming a mixture; depositing the mixture on the conducting layer, thereby forming an electrochromic precursor layer on the conducting layer; and thermally annealing the electrochromic precursor layer, thereby forming the precursor electrode. Depositing the mixture can, for example, comprise printing, lithographic deposition, spin coating, drop-casting, zone casting, dip coating, blade coating, spraying, vacuum filtration, slot die coating, curtain coating, or combinations thereof. Thermally annealing the electrochromic precursor layer can, for example, comprise heating the electrochromic precursor layer at a temperature of from 100° C. to 1000° C. In some examples, the electrochromic precursor layer is thermally annealed for from 1 minute to 24 hours. The electrochromic precursor layer can be thermally annealed, for example, in air, H₂, N₂, O₂, Ar, or combinations thereof.

In some examples, the method can further comprise forming the plurality of nanocrystals, the plurality of nanoparticles, or a combination thereof.

Also provided herein are methods of use of the electrochromic electrodes described herein. For example, the electrochromic electrodes described herein can be used as conductors in, for example, electronic displays, transistors, solar cells, and light emitting diodes (LEDs). Such devices can be fabricated by methods known in the art.

Also disclosed herein are electrochromic devices comprising the electrochromic electrodes disclosed herein; an electrolyte; and a counter electrode; wherein the electrochromic electrode and the counter electrode are in electrochemical contact with the electrolyte. The electrochromic device can comprise, for example, a touch panel, an electronic display, a transistor, a smart window, or a combination thereof.

Additional advantages will be set forth in part in the description that follows or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1 is a cross-sectional SEM image of a porous WO₃ film.

FIG. 2 is a top-down SEM image of a porous WO₃ film.

FIG. 3 is a schematic drawing of an Atomic Layer Deposition (ALD) system.

FIG. 4 is the structure of pentakis(dimentylamine)tantalum(V) (PDMAT).

FIG. 5 is the growth rate of TaOₓ versus temperature using ALD.

FIG. 6 is a cross-sectional SEM image of a porous WO₃ film with a conformal TaOₓ coating (a WO₃—Ta₂O₅ film).

FIG. 7 is a top-down SEM image of a porous WO₃ film with a conformal TaOₓ coating (a WO₃—Ta₂O₅ film).

FIG. 8 is a cross-sectional TEM image of a porous WO₃ film with a conformal TaOₓ coating (a WO₃—Ta₂O₅ film).

FIG. 9 is a top-down TEM image of a porous WO₃ film with a conformal TaOₓ coating (a WO₃—Ta₂O₅ film).

FIG. 10 is a high-res TEM-EDS image of the WO₃—Ta₂O₅ film.

FIG. 11 indicates the line perpendicular to the film along which an EDS line scan was performed.

FIG. 12 EDS line scan results along the line indicated in FIG. 11.

FIG. 13 EDS line scan results along the line indicated in FIG. 11.

FIG. 14 shows the transmittance spectra of a control sample (WO₃ only, no TaOₓ coating; bottom trace and bottom image), a sample with a 1 nm TaOₓ coating applied by ALD (second from bottom trace), and a sample with a 2 nm TaOₓ coating applied by ALD (third from bottom trace; middle image) after 3 hours of intense UV irradiation. A bleached (non-darkened) sample is also shown for comparison (top trace; top image).

FIG. 15 shows the transmittance of the TaOₓ coated WO₃ electrode under various conditions.

FIG. 16 shows the chronoamperometry kinetics of the electrodes with various thicknesses of TaOₓ coating.

FIG. 17 shows the switching speed over 200 cycles for the TaOₓ coated WO₃ electrode.

FIG. 18 shows the transmittance of the TaOₓ coated WO₃ electrode after 3 switching cycles and after 202 switching cycles.

FIG. 19 shows the absorbance of the TaOₓ coated WO₃ electrode after 3 switching cycles and after 202 switching cycles.

FIG. 20 shows the transmittance of the TaOₓ coated WO₃ electrode under various charge conditions.

FIG. 21 shows the absorbance of the TaOₓ coated WO₃ electrode under various charge conditions.

FIG. 22 shows the cyclic voltammograms of the WO₃ film (no Ta₂O₅ coating).

FIG. 23 shows the cyclic voltammograms of the TaOₓ coated WO₃ electrode.

FIG. 24 shows an overlay of a cyclic voltammogram of the bare WO₃ film and the TaOₓ coated WO₃ electrode.

### DETAILED DESCRIPTION

The methods and compositions described herein may be understood more readily by reference to the following detailed description of specific aspects of the disclosed subject matter and the Examples included therein.

Before the present methods and compositions are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “the compound” includes mixtures of two or more such compounds, reference to “an agent” includes mixture of two or more such agents, and the like.

“Optional” or “optionally” means that the subsequently described event or circumstance can or cannot occur, and that the description includes instances where the event or circumstance occurs and instances where it does not.

It is understood that throughout this specification the identifiers “first” and “second” are used solely to aid the reader in distinguishing the various components, features, or steps of the disclosed subject matter. The identifiers “first” and “second” are not intended to imply any particular order, amount, preference, or importance to the components or steps modified by these terms.

As used herein, the term “conformal layer” is meant to refer to a substantially uniform thickness deposited on a substrate. By “substantially uniform thickness” is meant that the variation in thickness is less than 20%.

Electrochromic Electrodes

Disclosed herein are electrochromic electrodes. The electrochromic electrodes can comprise a conducting layer; an electrochromic layer; and a conformal hole blocking layer; wherein the electrochromic layer is disposed between the conducting layer and the hole blocking layer such that the electrochromic layer is in electrical contact with the conducting layer and the hole blocking layer.

Electrochromic layers can control optical properties such as optical transmission, absorption, reflectance, and/or emittance in a continual but reversible manner on application of a voltage. Electrochromic layers can also be used to reduce near infrared transmission. Some electrochromic materials can be colored by reduction, such as WO₃, MoO₃, V₂O₅, Nb₂O₅ or TiO₂, and other electrochromic materials can be colored by oxidation, such as Cr₂O₃, MnO₂, CoO or NiO.

The electrochromic electrodes disclosed herein can exhibit improved properties compared to an electrode comprising the same conducting layer and electrochromic layer but without the conformal hole blocking layer. For example, the electrochromic electrodes can have a reduced photochromic effect as compared to an electrode comprising the same conducting layer and electrochromic layer but without the conformal hole blocking layer. Photochromism is the transformation of a chemical species between two forms by the absorption of electromagnetic radiation, where the two forms have different absorption spectra. In some examples, photochromism can be described as a change of color upon exposure to light.

In some examples, the electrochromic electrodes can have an average transmittance of 50% or more (e.g., 55% or more, 60% or more, 65% or more, 70% or more, 75% or more, 80% or more, 85% or more, 90% or more, 95% or more, or 99% or more) at one or more wavelengths from 400 nm to 2200 nm after irradiation with UV light for 3 hours or more (e.g., 4 hours or more, 5 hours or more, 6 hours or more, 7 hours or more, 8 hours or more, 9 hours or more, 10 hours or more, 11 hours or more, or 12 hours or more).

In some examples, the one or more wavelengths can be one or more wavelengths of 400 nm or more (e.g., 425 nm or more, 450 nm or more, 475 nm or more, 500 nm or more, 525 nm or more, 550 nm or more, 575 nm or more, 600 nm or more, 625 nm or more, 650 nm or more, 675 nm or more, 700 nm or more, 750 nm or more, 800 nm or more, 850 nm or more, 900 nm or more, 950 nm or more, 1000 nm or more, 1100 nm or more, 1200 nm or more, 1300 nm or more, 1400 nm or more, 1500 nm or more, 1600 nm or more, 1700 nm or more, 1800 nm or more, 1900 nm or more, 2000 nm or more, or 2100 nm or more). In some examples, the one or more wavelengths can be one or more wavelengths of 2200 nm or less (e.g., 2100 nm or less, 2000 nm or less, 1900 nm or less, 1800 nm or less, 1700 nm or less, 1600 nm or less, 1500 nm or less, 1400 nm or less, 1300 nm or less, 1200 nm or less, 1100 nm or less, 1000 nm or less, 950 nm or less, 900 nm or less, 850 nm or less, 800 nm or less, 750 nm or less, 700 nm or less, 675 nm or less, 650 nm or less, 625 nm or less, 600 nm or less, 575 nm or less, 550 nm or less, 525 nm or less, 500 nm or less, 475 nm or less, 450 nm or less, or 425 nm or less). The one or more wavelengths can range from any of the minimum values described above to any of the maximum values described above. For example, the one or more wavelengths can be from 400 nm to 2200 nm (e.g., from 400 nm to 1300 nm, 1300 nm to 2200 nm, from 400 nm to 700 nm, from 700 nm to 1000 nm, from 1000 nm to 1300 nm, from 1300 nm to 1600 nm, from 1600 nm to 1900 nm, from 1900 nm to 2200 nm, or from 450 nm to 2000 nm).

In some examples, the electrochromic electrodes can have a first optical state and a second optical state, wherein each of the first optical state and the second optical state has an average transmittance at one or more wavelengths from 400 nm to 2200 nm, wherein the average transmittance of the second optical state is less than the average transmittance of the first optical state by 20% or more (e.g., 25% or more, 30% or more, 35% or more, 40% or more, 45% or more, 50% or more, 55% or more, 60% or more, 65% or more, 70% or more, 75% or more, 80% or more, 85% or more, 90% or more, or 95% or more) at one or more wavelengths from 400 nm to 2200 nm. For example, the first optical state can be substantially transparent at one or more wavelengths from 400 nm to 2200 nm and the second optical state can be substantially opaque at one or more wavelengths from 400 nm to 2200 nm.

In some examples, the electrochromic electrode can be switched from the first optical state to the second optical state and/or from the second optical state to the first optical state upon application of a potential to the electrochromic electrode. In some examples, the potential applied to the electrochromic electrode can be 1.5 Volts (V) or more compared to a lithium metal reference (e.g., 1.75 V or more, 2 V or more, 2.25 V or more, 2.5 V or more, 2.75 V or more, 3 V or more, 3.25 V or more, 3.5 V or more, or 3.75 V or more). In some examples, the potential applied to the electrochromic electrode can be 4 V or less compared to a lithium metal references (e.g., 3.75 V or less, 3.5 V or less, 3.25 V or less, 3 V or less, 2.75 V or less, 2.5 V or less, 2.25 V or less, 2 V or less, or 1.75 V or less). The potential applied to the electrochromic electrode can range from any of the minimum values described above to any of the maximum values described above. For example, the potential applied to the electrochromic electrode can be from 1.5 V to 4 V compared to a lithium metal reference (e.g., from 1.5 V to 2.75 V, from 2.75 V to 4 V, from 1.5 V to 2 V, from 2 V to 2.5 V, from 2.5 V to 3 V, from 3 V to 3.5 V, from 3.5 V to 4 V, or from 1.75 V to 9.75 V). In some examples, the potential can be applied to the electrochromic electrode for 1 minute or more (e.g., 2 minutes or more, 3 minutes or more, 4 minutes or more, 5 minutes or more, 6 minutes or more, 7 minutes or more, 8 minutes or more, 9 minutes or more, 10 minutes or more, 11 minutes or more, 12 minutes or more, 13 minutes or more, 14 minutes or more, 15 minutes or more, 16 minutes or more, 17 minutes or more, 18 minutes or more, or 19 minutes or more). In some examples, the potential can be applied to the electrochromic electrode for 20 minutes or less (e.g., 19 minutes or less, 18 minutes or less, 17 minutes or less, 16 minutes or less, 15 minutes or less, 14 minutes or less, 13 minutes or less, 12 minutes or less, 11 minutes or less, 10 minutes or less, 9 minutes or less, 8 minutes or less, 7 minutes or less, 6 minutes or less, 5 minutes or less, 4 minutes or less, 3 minutes or less, or 2 minutes or less). The amount of time for which the potential is applied to the electrochromic electrode can range from any of the minimum values described above to any of the maximum values described above. For example, the potential can be applied to the electrochromic electrode for from 1 minute to 20 minutes (e.g., from 1 minute to 10 minutes, from 10 minutes to 20 minutes, from 1 minutes to 5 minutes, from 5 minutes to 10 minutes, from 10 minutes to 15 minutes, from 15 minutes to 20 minutes, or from 2 minutes to 19 minutes).

In some examples, the electrochromic electrodes can have a charge capacity that is stable. For example, the electrochromic electrodes can have a charge capacity that decreases by 5% or less (e.g., 4.75% or less, 4.5% or less, 4.25% or less, 4% or less, 3.75% or less, 3.5% or less, 3.25% or less, 3% or less, 2.75% or less, 2.5% or less, 2.25% or less, 2% or less, 1.75% or less, 1.5% or less, 1.25% or less, 1% or less, 0.75% or less, 0.5% or less, or 0.25% or less) after 200 cycles or more (e.g., 300 cycles or more, 400 cycles or more, 500 cycles or more, 600 cycles or more, 700 cycles or more, 800 cycles or more, 900 cycles or more, or 1000 cycles or more). As used herein, a cycle refers to the electrochromic electrode switching from the first optical state to the second optical state, and then back from the second optical state to the first optical state.

In some examples, the electrochromic electrodes can have an average absorbance at one or more wavelengths from 400 nm to 2200 nm that decreases by 5% or less (e.g., 4.75% or less, 4.5% or less, 4.25% or less, 4% or less, 3.75% or less, 3.5% or less, 3.25% or less, 3% or less, 2.75% or less, 2.5% or less, 2.25% or less, 2% or less, 1.75% or less, 1.5% or less, 1.25% or less, 1% or less, 0.75% or less, 0.5% or less, or 0.25% or less) after 200 cycles or more (e.g., 300 cycles or more, 400 cycles or more, 500 cycles or more, 600 cycles or more, 700 cycles or more, 800 cycles or more, 900 cycles or more, or 1000 cycles or more).

In some examples, hole blocking layer can comprise a metal oxide. Examples of metal oxides include simple binary metal oxides (e.g., with a single metal element) and mixed metal oxides (e.g., with different metal elements). The hole blocking layer can, for example, comprise a metal oxide where the metal is selected from Al, Hf, Nb, Ta, and combinations thereof. In some examples, the hole blocking layer can, for example, comprise a metal oxide where the metal is selected from Al, Hf, Nb, Ta, and combinations thereof, and wherein the oxygen is present in the metal oxide in a non-stoichiometric amount. In some examples, the hole blocking layer can comprise Ta₂O₅, Al₂O₃, Nb₂O₅, HfO₂, or combinations thereof.

The average thickness of the hole blocking layer can be selected to tune the optical and/or electrical properties of the electrochromic electrode. For example, the hole blocking layer can have an average thickness of 0.5 nanometers (nm) or more (e.g., 0.75 nm or more, 1 nm or more, 1.25 nm or more, 1.5 nm or more, 1.75 nm or more, 2 nm or more, 2.25 nm or more, 2.5 nm or more, 3 nm or more, 3.25 nm or more, 3.5 nm or more, 3.75 nm or more, 4 nm or more, 4.25 nm or more, 4.5 nm or more, 4.75 nm or more, 5 nm or more, 5.25 nm or more, 5.5 nm or more, 5.75 nm or more, 6 nm or more, 6.25 nm or more, 6.5 nm or more, 6.75 nm or more, 7 nm or more, 7.25 nm or more, 7.5 nm or more, 7.75 nm or more, 8 nm or more, 8.25 nm or more, 8.5 nm or more, 8.75 nm or more, 9 nm or more, 9.25 nm or more, 9.5 nm or more, or 9.75 nm or more). The thickness of the hole blocking layer can be determined, for example, using ellipsometry and/or electron microscopy.

In some examples, the hole blocking layer can have an average thickness of 10 nm or less (e.g., 9.75 nm or less, 9.5 nm or less, 9.25 nm or less, 9 nm or less, 8.75 nm or less, 8.5 nm or less, 8.25 nm or less, 8 nm or less, 7.75 nm or less, 7.5 nm or less, 7.25 nm or less, 7 nm or less, 6.75 nm or less, 6.5 nm or less, 6.25 nm or less, 6 nm or less, 5.75 nm or less, 5.5 nm or less, 5.25 nm or less, 5 nm or less, 4.75 nm or less, 4.5 nm or less, 4.25 nm or less, 4 nm or less, 3.75 nm or less, 3.5 nm or less, 3.25 nm or less, 3 nm or less, 2.75 nm or less, 2.5 nm or less, 2.25 nm or less, 2 nm or less, 1.75 nm or less, 1.5 nm or less, 1.25 nm or less, 1 nm or less, or 0.75 nm or less).

The average thickness of the hole blocking layer can range from any of the minimum values described above to any of the maximum values described above. For example, the hole blocking layer can have an average thickness of from 0.5 nm to 10 nm (e.g., from 0.5 nm to 4.75 nm, from 4.75 nm to 10 nm, from 0.5 nm to 2.5 nm, from 2.5 nm to 5 nm, from 5 nm to 7.5 nm, from 7.5 nm to 10 nm, from 0.75 nm to 8 nm, or from 1 nm to 5 nm).

In some examples, the electrochromic layer can comprise a metal oxide. Examples of metal oxides include simple metal oxides (e.g., with a single metal element) and mixed metal oxides (e.g., with different metal elements). In some examples, the electrochromic layer can comprise a metal oxide where the metal is selected from the group consisting of Cr, Co, Mn, Mo, Nb, Ni, Ti, V, W, and combinations thereof. In some examples, the electrochromic layer can comprise a metal oxide where the metal is selected from the group consisting of Cr, Co, Mn, Mo, Nb, Ni, Ti, V, W, and combinations thereof, and wherein the oxygen is present in the metal oxide in a non-stoichiometric amount. In some examples, the electrochromic layer can comprise WO₃, MoO₃, V₂O₅, Nb₂O₅, TiO₂, Cr₂O₃, MnO₂, CoO, NiO, or combinations thereof.

In some examples, the electrochromic layer can comprise a plurality of nanocrystals, a plurality of nanoparticles, or a combination thereof. The plurality of nanocrystals, plurality of nanoparticles, or a combination thereof can have an average particle size. “Average particle size,” “mean particle size,” and “median particle size” are used interchangeably herein, and generally refer to the statistical mean particle size of the nanocrystals and/or nanoparticles in a population of nanocrystals and/or nanoparticles. For example, the average particle size for a plurality of nanocrystals and/or nanoparticles with a substantially spherical shape can comprise the average diameter of the plurality of nanocrystals and/or nanoparticles. For a nanocrystal and/or nanoparticle with a substantially spherical shape, the diameter of a nanocrystal and/or nanoparticle can refer, for example, to the hydrodynamic diameter. As used herein, the hydrodynamic diameter of a nanocrystal and/or nanoparticle can refer to the largest linear distance between two points on the surface of the nanocrystal and/or nanoparticle. For an anisotropic nanocrystal and/or nanoparticle, the average particle size can refer to, for example, the average maximum dimension of the nanocrystal and/or nanoparticle (e.g., the length of a rod shaped particle, the diagonal of a cube shape particle, the bisector of a triangular shaped particle, etc.) For an anisotropic nanocrystal and/or nanoparticle, the average particle size can refer to, for example, the hydrodynamic size of the nanocrystal and/or nanoparticle. Mean particle size can be measured using methods known in the art, such as evaluation by scanning electron microscopy, transmission electron microscopy, and/or dynamic light scattering.

The plurality of nanocrystals, the plurality of nanoparticles, or a combination thereof can, for example, have an average particle size of 1 nm or more (e.g., 2 nm or more, 3 nm or more, 4 nm or more, 5 nm or more, 6 nm or more, 7 nm or more, 8 nm or more, 9 nm or more, 10 nm or more, 15 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 225 nm or more, 250 nm or more, 275 nm or more, 300 nm or more, 325 nm or more, 350 nm or more, 375 nm or more, 400 nm or more, 425 nm or more, 450 nm or more, 475 nm or more, 500 nm or more, 550 nm or more, 600 nm or more, 650 nm or more, 700 nm or more, 750 nm or more, 800 nm or more, 850 nm or more, 900 nm or more, or 950 nm or more). In some examples, the plurality of nanocrystals, the plurality of nanoparticles, or a combination thereof can have an average particle size of 1000 nm or less (e.g., 950 nm or less, 900 nm or less, 850 nm or less, 800 nm or less, 750 nm or less, 700 nm or less, 650 nm or less, 600 nm or less, 550 nm or less, 500 nm or less, 475 nm or less, 450 nm or less, 425 nm or less, 400 nm or less, 375 nm or less, 350 nm or less, 325 nm or less, 300 nm or less, 275 nm or less, 250 nm or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, 15 nm or less, 10 nm or less, 9 nm or less, 8 nm or less, 7 nm or less, 6 nm or less, 5 nm or less, 4 nm or less, 3 nm or less, or 2 nm or less).

The average particle size of the plurality of nanocrystals, the plurality of nanoparticles, or a combination thereof can range from any of the minimum values described above to any of the maximum values described above. For examples, the plurality of nanocrystals, the plurality of nanoparticles, or a combination thereof can have an average particle size of from 1 nm to 1000 nm (e.g., from 1 nm to 500 nm, from 500 nm to 1000 nm, from 1 nm to 200 nm, form 200 nm to 400 nm, from 400 nm to 600 nm, from 600 nm to 800 nm, from 800 nm to 1000 nm, or from 10 nm to 900 nm).

In some examples, the plurality of nanocrystals, the plurality of nanoparticles, or a combination thereof can be substantially monodisperse. “Monodisperse” and “homogeneous size distribution,” as used herein, and generally describe a population of nanocrystals and/or nanoparticles where all of the nanocrystals and/or nanoparticles are the same or nearly the same size. As used herein, a monodisperse distribution refers to nanocrystal and/or nanoparticle size distributions in which 70% of the distribution (e.g., 75% of the distribution, 80% of the distribution, 85% of the distribution, 90% of the distribution, or 95% of the distribution) lies within 25% of the median particle size (e.g., within 20% of the median particle size, within 15% of the median particle size, within 10% of the median particle size, or within 5% of the median particle size).

The plurality of nanocrystals, the plurality of nanoparticles, or a combination thereof can comprise nanocrystals and/or nanoparticles of any shape (e.g., sphere, rod, cube, rectangle, octahedron, truncated octahedron, plate, cone, prism, ellipse, triangle, etc.). In some examples, the plurality of nanocrystals, the plurality of nanoparticles, or a combination thereof can have an isotropic shape. In some examples, the plurality of nanocrystals, the plurality of nanoparticles, or a combination thereof can have an anisotropic shape.

In some examples, the conducting layer can comprise a transparent conducting oxide, a carbon material, a nanostructured metal, or a combination thereof. As used herein, “nanostructured” means any structure with one or more nanosized features. A nanosized feature can be any feature with at least one dimension less than 1 μm in size. For example, a nanosized feature can comprise a nanowire, nanotube, nanoparticle, nanopore, and the like, or combinations thereof. As such, the nanostructured metal can comprise, for example, a nanowire, nanotube, nanoparticle, nanopore, or a combination thereof. In some examples, the nanostructured metal can comprise a metal that is not nanosized but has been modified with a nanowire, nanotube, nanoparticle, nanopore, or a combination thereof. The nanostructured metal can comprise, for example, a metal selected from the group consisting of Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Hg, Tl, Pb, Bi, La, Ce, Pr, Nd, Pm, Sm, Eu, Gd, Tb, Dy, Ho, Er, Tm, Yb, and combinations thereof.

Examples of carbon materials include, but are not limited to, graphitic carbon and graphites, including pyrolytic graphite (e.g., highly ordered pyrolytic graphite (HOPG)) and isotropic graphite, amorphous carbon, carbon black, single- or multi-walled carbon nanotubes, graphene, glassy carbon, diamond-like carbon (DLC) or doped DLC, such as boron-doped diamond, pyrolyzed photoresist films, and others known in the art.

In some examples, the conducting layer can comprise a transparent conducting oxide. In some examples, the conducting layer can comprise a metal oxide. Examples of metal oxides include simple metal oxides (e.g., with a single metal element) and mixed metal oxides (e.g., with different metal elements). The metal oxide can, for example, comprise a metal selected from the group consisting of Cd, Cr, Cu, Ga, In, Ni, Sn, Ti, W, Zn, and combinations thereof. In some examples, the conducting layer can comprise, CdO, CdIn₂O₄, Cd₂SnO₄, Cr₂O₃, CuCrO₂, CuO₂, Ga₂O₃, In₂O₃, NiO, SnO₂, TiO₂, ZnGa₂O₄, ZnO, InZnO, InGaZnO, InGaO, ZnSnO, Zn₂SnO₄, CdSnO, WO₃, or combinations thereof.

In some examples, the conducting layer can further comprise a dopant. The dopant can comprise any suitable dopant for the conducting layer. The dopant can, for example, be selected to tune the optical and/or electronic properties of the nanostructured conducting film. In some examples, the dopant can comprise an n-type dopant. The dopant can, for example, comprise Al, B, Ce, Cl, Cs, Dy, Er, Eu, F, Ga, Gd, Ho, In, La, Mg, Mo, N, Nb, Nd, Sb, Sn, Sm, Tb, or combinations thereof.

In some examples, the conducting layer can comprise a transparent conducting oxide selected from indium doped tin oxide, tin doped indium oxide, fluorine doped tin oxide, and combinations thereof.

Methods of Making

Also described herein are methods of making the electrochromic electrodes described herein. For example, also disclosed herein are methods of making the electrochromic electrodes described herein, the method comprising: providing a precursor electrode, the precursor electrode comprising the conducting layer and the electrochromic layer; and depositing the hole blocking layer conformally on the electrochromic layer of the precursor electrode; thereby forming the electrochromic electrode.

Conformally depositing the hole blocking layer can, for example, comprise atomic layer deposition, chemical vapor deposition, electron beam evaporation, thermal evaporation, sputtering deposition, pulsed laser deposition, or combinations thereof.

Chemical vapor deposition (CVD) is a thin film deposition technique that is based on the sequential use of a gas phase chemical process. A variety of chemical vapor apparatus can be used. A chemical vapor deposition apparatus typically comprises a horizontal tubular reactor equipped with a susceptor for mounting a substrate thereon, a heater for heating the substrate, a feed gas introduction portion arranged such that the direction of the feed gas fed in a tubular reactor is made parallel to the substrate, and a reaction gas exhaust portion. Thus the substrate is placed on the susceptor in the tubular reactor, the substrate is heated, and a gas containing a feed gas is supplied in the reactor in the direction parallel to the substrate so that a chemical vapor deposition forms a film on the substrate. See U.S. Pat. No. 6,926,920, U.S. Publication No. 2002-0160112, which are incorporated by reference herein for their teachings of CVD techniques.

Atomic layer deposition is a thin film deposition technique that is based on the sequential use of a gas phase chemical process. The majority of ALD reactions use two chemicals, typically called precursors. These precursors react with a surface one at a time in a sequential, self-limiting, manner By exposing the precursors to the growth surface repeatedly, a thin film is deposited.

ALD is a self-limiting (the amount of film material deposited in each reaction cycle is constant), sequential surface chemistry that deposits conformal thin-films of materials onto substrates of varying compositions. Due to the characteristics of self-limiting and surface reactions, ALD film growth makes atomic scale depositions control possible. ALD is similar in chemistry to chemical vapor deposition, except the ALD reaction breaks the CVD reaction into two half-reactions, keeping the precursor materials separate during the reaction. By keeping the precursors separate throughout the coating process, atomic layer control of film growth can be obtained as fine as ˜0.1 Å per cycle. Separation of the precursors is accomplished by pulling a purge gas (such as nitrogen or argon) after each precursor pulse to remove excess precursor from the process chamber and prevent ‘parasitic’ CVD deposition on the substrate.

The growth of material layers by ALD involves repeating the following characteristic four steps: (1) contacting the substrate with the first precursor; (2) purge or evacuation of the reaction chamber to remove the non-reacted precursors and the gaseous reaction by-products; (3) contacting the substrate with the second precursor—or another treatment to activate the surface again for the reaction of the first precursor, such as a plasma; (4) purge or evacuation of the reaction chamber. Each reaction cycle adds a given amount of material to the surface of the substrate, referred to as the growth per cycle. To grow a material layer, reaction cycles are repeated as many times as required for the desired film thickness. One cycle may take from about 0.5 seconds to a few seconds and deposit from about 0.1 to about 3 Å of film thickness. Due to the self-terminating reactions, ALD is a surface-controlled process, where process parameters other than the precursors, substrate, and temperature have little or no influence. And, because of the surface control, ALD-grown films are extremely conformal and uniform in thickness. These thin films can also be used in correlation with other common fabrication methods.

Using ALD, film thickness depends only on the number of reaction cycles, which makes the thickness control accurate and simple. There is less need of reactant flux homogeneity, which gives large area (large batch and easy scale-up) capability, excellent conformality and reproducibility, and simplifies the use of solid precursors. Also, the growth of different multilayer structures is straight forward. Other advantages of ALD are the wide range of film materials available, high density and low impurity level. Also, lower deposition temperature can be used in order not to affect sensitive substrates.

In some examples, conformally depositing the hole blocking layer comprises electrodeposition. Electrodeposition of the hole blocking layer can, for example, comprise: contacting the precursor electrode with a solution comprising a hole blocking layer precursor; and applying a potential to the precursor electrode while it is in contact with the solution, thereby depositing the hole blocking layer on the precursor electrode.

In some examples, conformally depositing the hole blocking layer can comprise conformally depositing a hole blocking layer precursor and thermally annealing the hole blocking layer precursor to form the hole blocking layer. For example, the hole blocking layer precursor can comprise a plurality of nanocrystals, a plurality of nanoparticles, or a combination thereof dispersed in a solution and conformally depositing the hole blocking layer precursor can comprise printing, lithographic deposition, spin coating, drop-casting, zone casting, dip coating, blade coating, spraying, vacuum filtration, slot die coating, curtain coating, or combinations thereof. Thermally annealing the hole blocking layer precursor can, for example, comprise heating the hole blocking layer precursor at a temperature of from 100° C. to 1000° C. In some examples, the hole blocking layer precursor is thermally annealed for from 1 minute to 24 hours. The hole blocking layer precursor can be thermally annealed, for example, in air, H₂, N₂, O₂, Ar, or combinations thereof.

Thermally annealing the hole blocking layer precursor can, for example, comprise heating the hole blocking layer precursor at a temperature of 100° C. or more (e.g., 150° C. or more, 200° C. or more, 250° C. or more, 300° C. or more, 350° C. or more, 400° C. or more, 450° C. or more, 500° C. or more, 550° C. or more, 600° C. or more, 650° C. or more, 700° C. or more, 750° C. or more, 800° C. or more, 850° C. or more, 900° C. or more, or 950° C. or more). In some examples, thermally annealing the hole blocking layer precursor can comprise heating the hole blocking layer precursor at a temperature of 1000° C. or less (e.g., 950° C. or less, 900° C. or less, 850° C. or less, 800° C. or less, 750° C. or less, 700° C. or less, 650° C. or less, 600° C. or less, 550° C. or less, 500° C. or less, 450° C. or less, 400° C. or less, 350° C. or less, 300° C. or less, 250° C. or less, 200° C. or less, or 150° C. or less). The temperature at which the hole blocking layer precursor is heated to thermally anneal the hole blocking layer precursor can range from any of the minimum values described above to any of the maximum values described above. For examples, thermally annealing the hole blocking layer precursor can comprise heating the hole blocking layer precursor at a temperature of from 100° C. to 1000° C. (e.g., from 100° C. to 500° C., from 500° C. to 1000° C., from 100° C. to 250° C., from 250° C. to 400° C., from 400° C. to 550° C., from 550° C. to 700° C., from 700° C. to 850° C., from 850° C. to 1000° C., or from 200° C. to 900° C.).

In some examples, the hole blocking layer precursor can be thermally annealed for 1 minute or more (e.g., 5 minutes or more, 10 minutes or more, 15 minutes or more, 20 minutes or more, 25 minutes or more, 30 minutes or more, 45 minutes or more, 1 hour or more, 1.5 hours or more, 2 hours or more, 2.5 hours or more, 3 hours or more, 3.5 hours or more, 4 hours or more, 4.5 hours or more, 5 hours or more, 5.5 hours or more, 6 hours or more, 7 hours or more, 8 hours or more, 9 hours or more, 10 hours or more, 11 hours or more, 12 hours or more, 13 hours or more, 14 hours or more, 15 hours or more, 16 hours or more, 17 hours or more, 18 hours or more, 19 hours or more, 20 hours or more, 21 hours or more, 22 hours or more, or 23 hours or more). In some examples, the hole blocking layer precursor can be thermally annealed for 24 hours or less (e.g., 23 hours or less, 22 hours or less, 21 hours or less, 20 hours or less, 19 hours or less, 18 hours or less, 17 hours or less, 16 hours or less, 15 hours or less, 14 hours or less, 13 hours or less, 12 hours or less, 11 hours or less, 10 hours or less, 9 hours or less, 8 hours or less, 7 hours or less, 6 hours or less, 5.5 hours or less, 5 hours or less, 4.5 hours or less, 4 hours or less, 3.5 hours or less, 3 hours or less, 2.5 hours or less, 2 hours or less, 1.5 hours or less, 1 hour or less, 45 minutes or less, 30 minutes or less, 25 minutes or less, 20 minutes or less, 15 minutes or less, 10 minutes or less, or 5 minutes or less). The time for which the hole blocking layer precursor is thermally annealed can range from any of the minimum values described above to any of the maximum values described above. For example, the hole blocking layer precursor can be thermally annealed for from 1 minute to 24 hours (e.g., from 1 minute to 12 hours, from 12 hours to 24 hours, from 1 minute to 6 hours, from 6 hours to 12 hours, from 12 hours to 18 hours, from 18 hours to 24 hours, or from 5 minutes to 23 hours).

In some examples, the methods can further comprise forming the precursor electrode. Forming the precursor electrode can comprise, for example, dispersing a plurality of nanocrystals, a plurality of nanoparticles, or a combination thereof in a solution, thereby forming a mixture; depositing the mixture on the conducting layer, thereby forming an electrochromic precursor layer on the conducting layer; and thermally annealing the electrochromic precursor layer, thereby forming the precursor electrode. Depositing the mixture can, for example, comprise printing, lithographic deposition, spin coating, drop-casting, zone casting, dip coating, blade coating, spraying, vacuum filtration, slot die coating, curtain coating, or combinations thereof.

Thermally annealing the electrochromic precursor layer can, for example, comprise heating the electrochromic precursor layer at a temperature of 100° C. or more (e.g., 150° C. or more, 200° C. or more, 250° C. or more, 300° C. or more, 350° C. or more, 400° C. or more, 450° C. or more, 500° C. or more, 550° C. or more, 600° C. or more, 650° C. or more, 700° C. or more, 750° C. or more, 800° C. or more, 850° C. or more, 900° C. or more, or 950° C. or more). In some examples, thermally annealing the electrochromic precursor layer can comprise heating the electrochromic precursor layer at a temperature of 1000° C. or less (e.g., 950° C. or less, 900° C. or less, 850° C. or less, 800° C. or less, 750° C. or less, 700° C. or less, 650° C. or less, 600° C. or less, 550° C. or less, 500° C. or less, 450° C. or less, 400° C. or less, 350° C. or less, 300° C. or less, 250° C. or less, 200° C. or less, or 150° C. or less). The temperature at which the electrochromic precursor layer is heated to thermally anneal the electrochromic precursor layer can range from any of the minimum values described above to any of the maximum values described above. For examples, thermally annealing the electrochromic precursor layer can comprise heating the electrochromic precursor layer at a temperature of from 100° C. to 1000° C. (e.g., from 100° C. to 500° C., from 500° C. to 1000° C., from 100° C. to 250° C., from 250° C. to 400° C., from 400° C. to 550° C., from 550° C. to 700° C., from 700° C. to 850° C., from 850° C. to 1000° C., or from 200° C. to 900° C.).

In some examples, the electrochromic precursor layer can be thermally annealed for 1 minute or more (e.g., 5 minutes or more, 10 minutes or more, 15 minutes or more, 20 minutes or more, 25 minutes or more, 30 minutes or more, 45 minutes or more, 1 hour or more, 1.5 hours or more, 2 hours or more, 2.5 hours or more, 3 hours or more, 3.5 hours or more, 4 hours or more, 4.5 hours or more, 5 hours or more, 5.5 hours or more, 6 hours or more, 7 hours or more, 8 hours or more, 9 hours or more, 10 hours or more, 11 hours or more, 12 hours or more, 13 hours or more, 14 hours or more, 15 hours or more, 16 hours or more, 17 hours or more, 18 hours or more, 19 hours or more, 20 hours or more, 21 hours or more, 22 hours or more, or 23 hours or more). In some examples, the electrochromic precursor layer is thermally annealed for 24 hours or less (e.g., 23 hours or less, 22 hours or less, 21 hours or less, 20 hours or less, 19 hours or less, 18 hours or less, 17 hours or less, 16 hours or less, 15 hours or less, 14 hours or less, 13 hours or less, 12 hours or less, 11 hours or less, 10 hours or less, 9 hours or less, 8 hours or less, 7 hours or less, 6 hours or less, 5.5 hours or less, 5 hours or less, 4.5 hours or less, 4 hours or less, 3.5 hours or less, 3 hours or less, 2.5 hours or less, 2 hours or less, 1.5 hours or less, 1 hour or less, 45 minutes or less, 30 minutes or less, 25 minutes or less, 20 minutes or less, 15 minutes or less, 10 minutes or less, or 5 minutes or less). The time for which the electrochromic precursor layer is thermally annealed can range from any of the minimum values described above to any of the maximum values described above. For example, the electrochromic precursor layer can be thermally annealed for from 1 minute to 24 hours (e.g., from 1 minute to 12 hours, from 12 hours to 24 hours, from 1 minute to 6 hours, from 6 hours to 12 hours, from 12 hours to 18 hours, from 18 hours to 24 hours, or from 5 minutes to 23 hours).

The electrochromic precursor layer can be thermally annealed, for example, in air, H₂, N₂, O₂, Ar, or combinations thereof.

In some examples, the method can further comprise forming the plurality of nanocrystals, the plurality of nanoparticles, or a combination thereof.

Methods of Use

Also provided herein are methods of use of the electrochromic electrodes described herein. For example, the electrochromic electrodes described herein can be used as conductors in, for example, electronic displays, transistors, solar cells, and light emitting diodes (LEDs). Such devices can be fabricated by methods known in the art.

In some examples, the electrochromic electrodes described herein can be used in various articles of manufacture including electronic devices, energy storage devices, energy conversion devices, optical devices, optoelectronic devices, or combinations thereof. Examples of articles of manufacture (e.g., devices) using the electrochromic electrodes described herein can include, but are not limited to touch panels, electronic displays, transistors, smart windows, solar cells, fuel cells, photovoltaic cells, and combinations thereof. Such articles of manufacture can be fabricated by methods known in the art.

Also disclosed herein are electrochromic devices comprising the electrochromic electrodes disclosed herein; an electrolyte; and a counter electrode; wherein the electrochromic electrode and the counter electrode are in electrochemical contact with the electrolyte. In response to electrical stimulus, electronic charge moves in or out of the electrochromic layer and ionic charge from the electrolyte migrates towards or away from the electrochromic layer, thus effecting the optical properties of the electrochromic material. The electrochromic device can comprise, for example, a touch panel, an electronic display, a transistor, a smart window, or a combination thereof.

The examples below are intended to further illustrate certain aspects of the methods and compounds described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

Electrochromic films comprising tungsten oxide (WO₃) perform efficient light modulation when electrochemical biases are applied. However, WO₃ also exhibits photochromic darkening of its color when irradiated under UV light, which can be detrimental to the electrochromic switchability in the presence of sunlight. The exiting ideas for addressing this use generally involve blocking UV light by adding a UV-selective Bragg filter or UV-absorbing materials. However, efficient Bragg filters are highly expensive, and UV blocking materials can deteriorate the device performance and transparency.

Disclosed herein are methods for modifying the materials' interface to selectively transfer the charges necessary for electrochromism but not for photochromism. This only requires very thin (e.g., <10 nm) layer of inexpensive metal oxides by a cost effective deposition technique (e.g., ALD, or other deposition method). As an additional advantage, an increase of the device's switching stability was observed with the coating. Thus the methods described herein are cost effective, durable, and assist the device's performance, which is promising for applications such as smart-windows, filters, displays, and sensors. The methods described herein can be applicable to any type of electrochromic device

### Example 1—Formation of Electrochromic Layers

To synthesize WO₃ nanocrystals, 20 mL of oleic acid (Aldrich) was mixed with 2 mL of oleylamine (Aldrich) and degassed under vacuum at 120° C. for one hour. 340 mg of tungsten(IV) chloride (WCl₄) powder was stirred in 4 mL of oleic acid and injected into the solvent mixture heated to 300° C. The reaction quickly turned to dark blue in color and was cooled to room temperature 10 minutes after the injection. The WO₃ nanocrystal solution was transferred into a glove box, precipitated by adding an excess volume of isopropyl alcohol (Aldrich), centrifuged, and the collected pellet (comprising WO₃ nanocrystals) was dispersed in 10 mL of hexane (Aldrich).

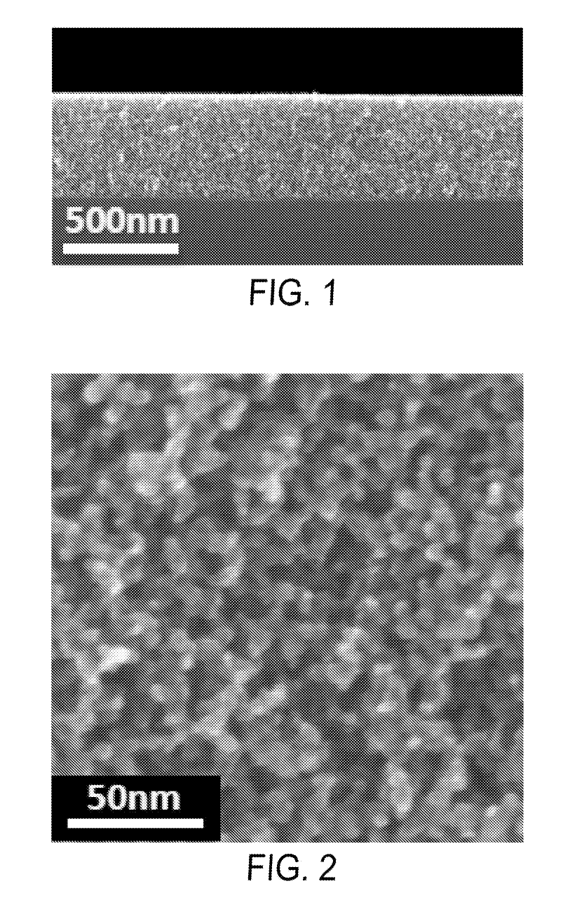

The WO₃ nanocrystal solution was freshly washed and then dispersed in 1:1 hexane/octane mixture adjusting the concentration at 30 mg/mL. A 1:1 mixture of oleic acid and oleylamine was added (30 μL) as porogens in the 1 mL of the as prepared nanocrystal solution. This solution was spin-coated (1000 rpm) on ITO-coated glass substrates (Diamond Coatings Limited, 20 mm×20 mm×1.1 mm, ˜60 Ω/sq sheet resistance) and then annealed in air at 400° C. for one hour, thereby forming a random mesoporous WO₃ nanocrystal film. A cross-sectional SEM image of a porous WO₃ film is shown in FIG. 1. A top-down SEM image of a porous WO₃ film is shown in FIG. 2.

### Example 2—Electrodeposition of Transition Metal Oxide Conformal Coatings

In some cases, conformal coatings of transition metal oxides (e.g., NbOₓ, TaOₓ) were deposited onto the WO₃ nanocrystals films using electrodeposition.

Amorphous niobium oxide (NbOₓ) was electrodeposited using a three electrode electrochemical cell with ITO-coated glass (200 ohm-cm) acting as the working electrode, platinum foil as the counter electrode, and Ag⁺/AgCl as the reference electrode. The electrolyte was a 0.1 M TMACl (tetramethylammonium chloride) aqueous solution. The polyoxoniobate precursor [(CH3)₄N]₅[H₃Nb₆O₁₉] was dissolved in the electrolyte to prepare a 10 mg/ml polyoxoniobate aqueous solution. Once all the electrodes were submerged in the electrolyte, a constant voltage was applied (typically 3.0 to 3.75 V) for two minutes in order to produce a water-splitting reaction and generate acid at the working electrode surface. The presence of acid induced the condensation of polyoxoniobates since they are only stable at a pH range between 11 and 14, which led to the deposition of a thin NbOₓ layer on the surface of the ITO-coated glass working electrode. The as-deposited films were thin (less than 70 nm depending on the voltage applied), transparent, and uniform.

Amorphous tantalum oxide (TaOₓ) was electrodeposited using a three electrode electrochemical cell with ITO-coated glass (200 ohm-cm) acting as the working electrode, platinum foil as the counter electrode, and Ag⁺/AgCl as the reference electrode. The electrolyte was a 0.1 M TMACl (tetramethylammonium chloride) aqueous solution. The polyoxotantalate precursor [(CH3)₄N]₆[H₂Ta₆O₁₉] was dissolved in the electrolyte to prepare a 10 mg/ml polyoxotantalate aqueous solution. Once all the electrodes were submerged in the electrolyte, a constant voltage is applied (typically 2.5 to 2.7 V) for two minutes in order to produce a water-splitting reaction and generate acid at the working electrode surface. The presence of acid induced the condensation of polyoxotantalates since they are only stable at a pH range between 11 and 14, which led to the deposition of a thin TaOₓ layer on the surface of the ITO-coated glass working electrode. The as-deposited films were thin (less than 50 nm depending on the voltage applied), transparent, and uniform.

When nanocrystals are templated on the ITO-coated glass substrate, a thin conformal coating is electrochemically deposited on the nanocrystal surface.

### Example 3—Deposition of Transition Metal Oxide Conformal Coatings Via ALD

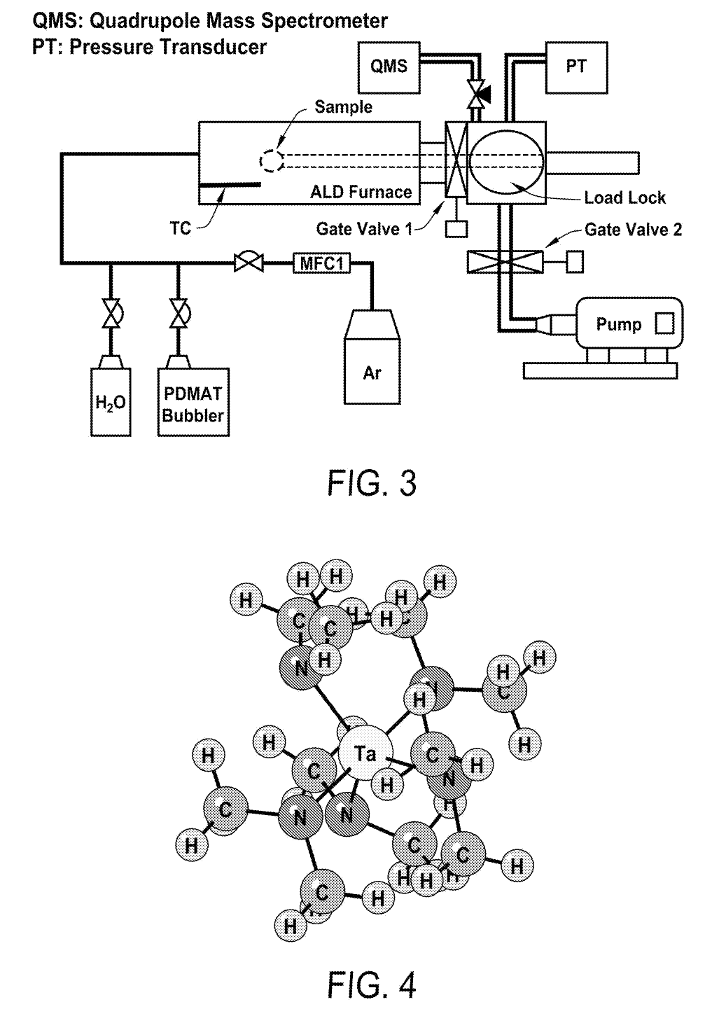

In some cases, conformal coatings of transition metal oxides (e.g., TaOₓ, ZnO) were deposited onto the WO₃ nanocrystals films using Atomic Layer Deposition (ALD). A schematic of the ALD system is shown in FIG. 3. For the deposition of TaOₓ conformal coatings, pentakis(dimethylamino)tantalum(V) (PDMAT) was used as the precursor. The structure of PDMAT is shown in FIG. 4. PDMAT is a solid at room temperature and has a partial pressure of 0.2 Torr at 74° C.

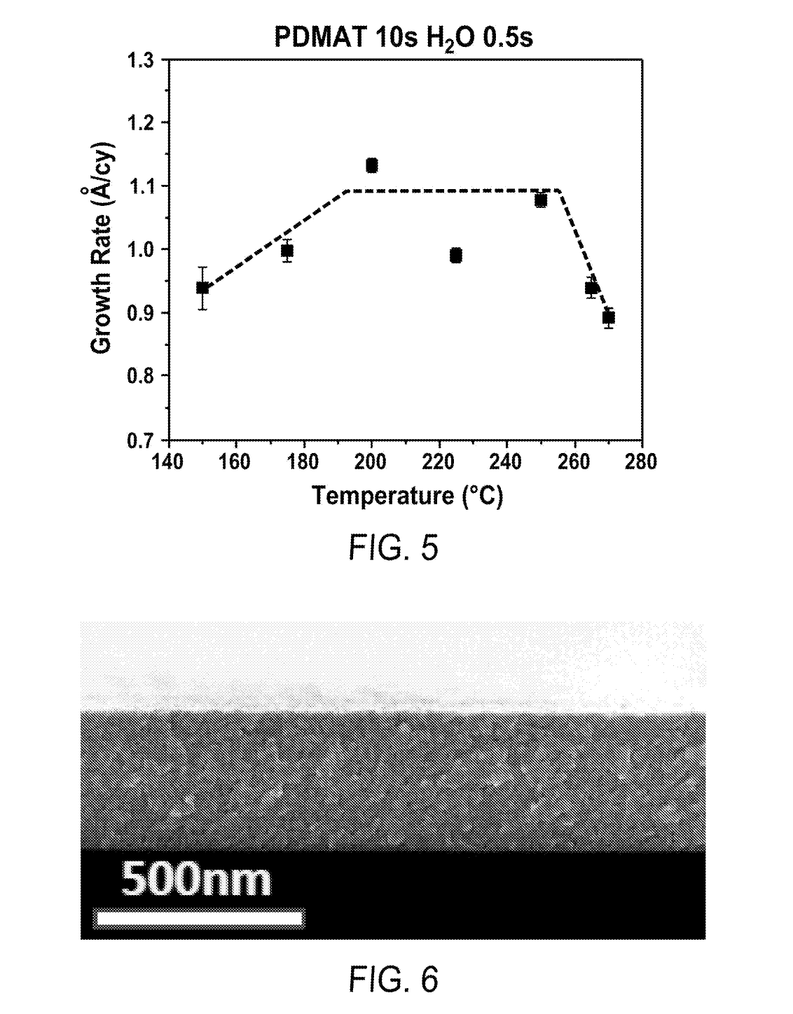

For the ALD deposition of Ta₂O₅ the PDMAT bubbler was heated at 74° C., the H₂O was under room temperature (26° C.), all pipelines and valves in the ALD system were heated at 70° C., and the base pressure of the ALD furnace was <10 mTorr. For the ALD deposition of Ta₂O₅ the temperature was 250° C., the carrier gas was Argon, the flow rate of Ar through the bubbler (MFC 2) was 120 sccm, and the flow rate of Argon during the pulse (MFC 1) was 120 sccm. The ALD recipe for Ta₂O₅ is PDMAT for 10 seconds, Ar for 20 seconds, H₂O for 0.5 seconds and Ar for 20 seconds. The growth rate of Ta₂O₅ using this recipe was 1.05 Å/cycle. The growth rate versus temperature is shown in FIG. 5.

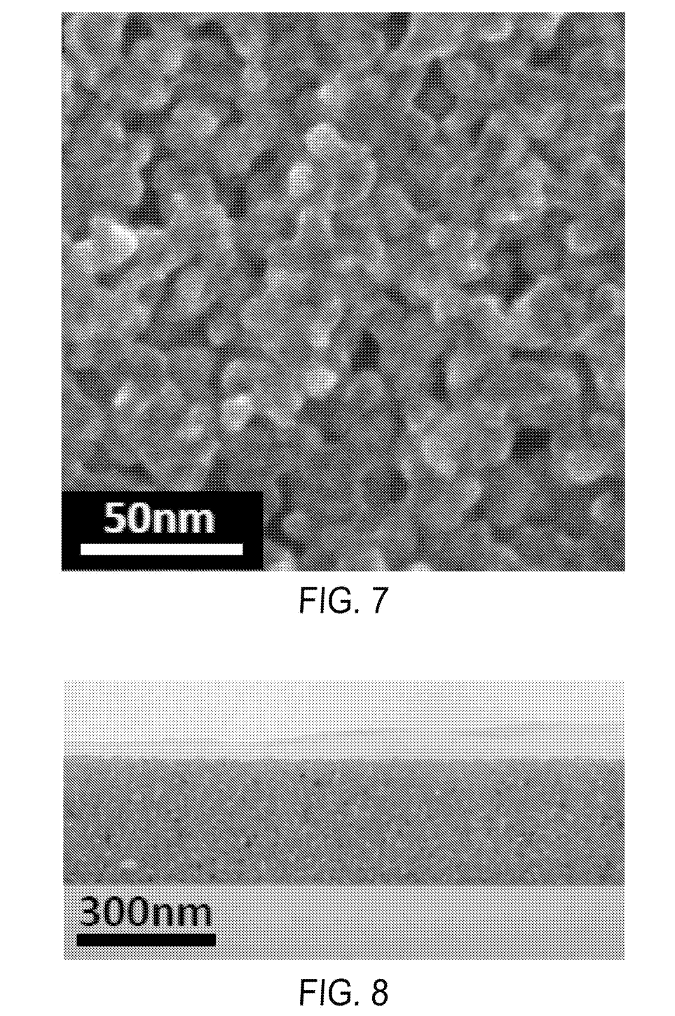

A cross-sectional SEM image of a porous WO₃ film with a conformal TaOₓ coating deposited via ALD (a WO₃—Ta₂O₅ film) is shown in FIG. 6. A top-down SEM image of a porous WO₃ film with a conformal TaOₓ coating deposited via ALD (a WO₃—Ta₂O₅ film) is shown in FIG. 7.

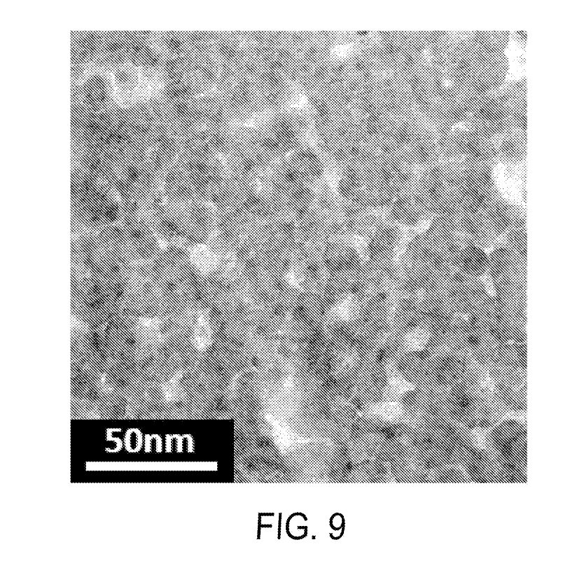

A cross-sectional TEM image of a porous WO₃ film with a conformal TaOₓ coating deposited via ALD (a WO₃—Ta₂O₅ film) is shown in FIG. 8. A top-down TEM image of a porous WO₃ film with a conformal TaOₓ coating deposited via ALD (a WO₃—Ta₂O₅ film) is shown in FIG. 9.

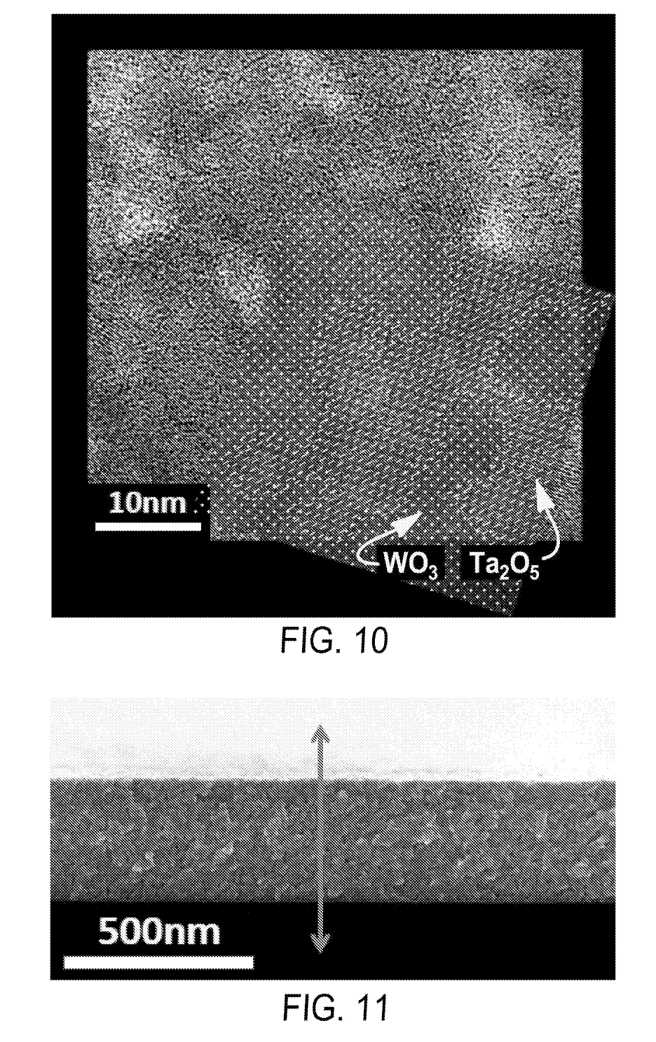

FIG. 10 is a high-res TEM-EDS image of the WO₃—Ta₂O₅ film formed via ALD, the EDS mapping shows that Ta₂O₅ is present everywhere and is coating the surface of the WO₃ film, partially filling in the pore spaces.

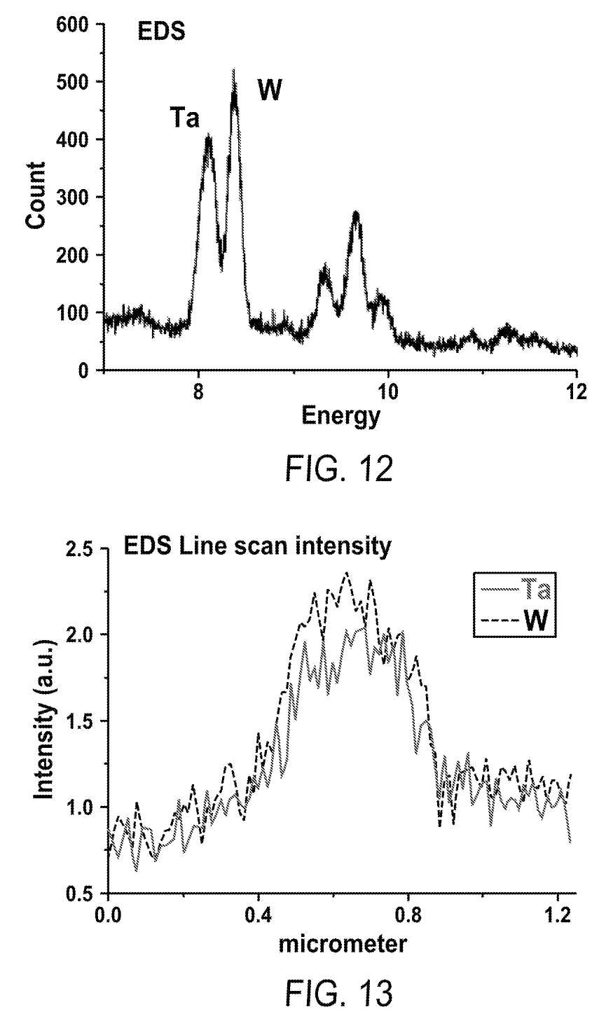

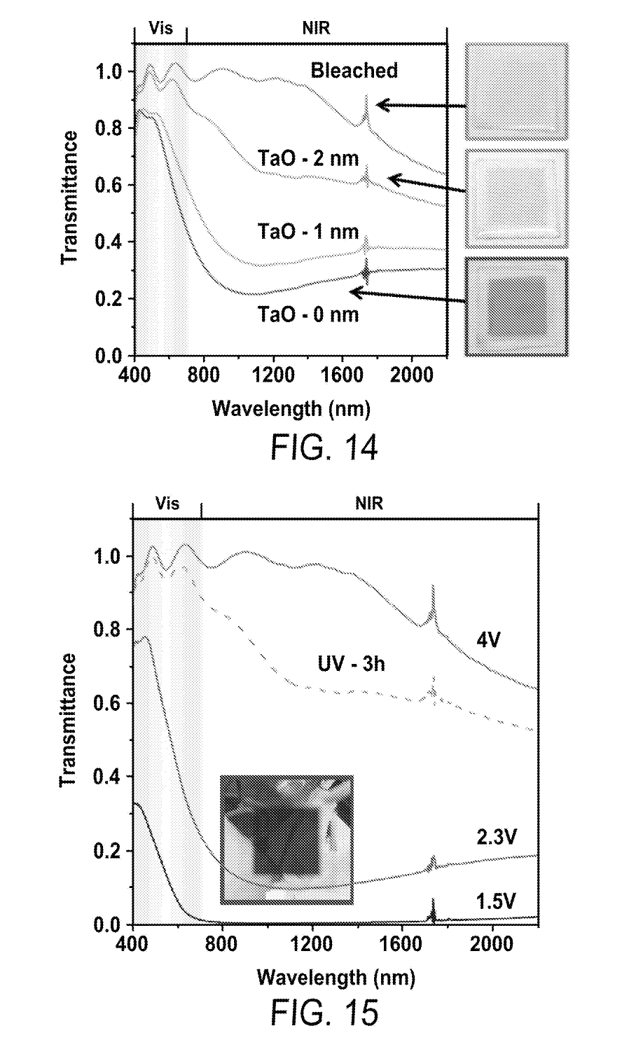

FIG. 11 indicates the line perpendicular to the WO₃—Ta₂O₅ film formed via ALD along which an EDS line scan was performed. The results of said EDS line scan shown in FIG. 12, confirm the presence of Ta and W. The results of said EDS line scan shown in FIG. 13 demonstrate that the TaOₓ coating deposited using ALD is substantially uniform through the thickness of the film.

### Example 4—Performance of the Electrochromic Electrodes

Disclosed herein are systems and methods for blocking the intrinsic photochromic mechanism of WO₃ that causes UV-darkening. The invention utilizes a thin (e.g., <10 nm thick) conformal coating of high-dielectric and ion-conductions material (e.g., Ta₂O₅) as a protective layer on the electrochromic WO₃ film. This thin layer efficiently shuts off photochromism by blocking the hole-transfer while still allowing the transfer of ions required for the electrochromic switching.

The systems described herein are capable of significant reduction of UV-darkening of WO₃ nanocrystal film under irradiation of UV-light with the intensity equivalent to the mid-day sunlight. Additionally, the systems show great cycling stability that exceeds the stability of a WO₃ nanocrystal film lacking the conformal coating.

A possible disadvantage of the systems is a decrease of switching speed as the conformal coating may hinder the ion transfer between WO₃ and electrolyte. This possibility can be minimized by appropriate choice of material for the conformal coating. For example, the choice of Ta₂O₅ as a preferred material considers its highly ion-conductive property. With optimized thickness (˜2 nm) of the coating, it was found that there was only a slight decrease of the switching speed, which would not significantly affect the full device performance.

The resulting system is capable of on-demand electrochromic switching not being harmed by UV-darkening even under intense solar irradiation. The coating process is cost effective compared to other methods to avoid UV-darkening. The optical switching is rapid and reversible at least over thousands of cycles.

A homebuilt spectroelectrochemical cell installed in a glove box was used for the electrochemical operations and the in-situ optical measurements. The mesoporous WO₃ (e.g., control sample with no coating, fabricated as described in Example 1), WO₃@TaOₓ films (fabricated via ALD), and WO₃@ZnO films (fabricated via ALD) were placed as working electrodes in the cell connected to the spectrometer and the light source guided with fiber-optic cables. For the Li⁺ ion charging experiment, three-electrode configuration with a single Li foil as counter and reference electrodes was used with 0.1 M Li-TFSI (Aldrich) in tetraglyme (Aldrich) as electrolyte. A potentiostat (Bio-logic VMP3) was used for chronoamperometry (CA) and cyclic voltammetry (CV) studies in between 1.5-4 V (vs. Li), and the optical transmission spectra were collected in-situ. The cycling stability was measured upon CA with a cycle rate selected to obtain the peak optical density above 80% of the saturated value.

To test the UV stability of the samples, the mesoporous WO₃, WO₃@TaOₓ, and WO₃@ZnO film samples were soaked with the same electrolyte (0.1 M LiTFSI/TG) by wetting the film surface with 100 μL of electrolyte and then placed under a UV lamp (Spectroline ENF-280C—365 nm) with a distance of 1 cm. The UV irradiance measured at this distance was 3.5 mW/cm² (similar to the integrated solar UV irradiance). The Vis-NIR transmittance was measured after 4 hours of UV irradiation using the same spectrometer setup used for spectroelectrochemical measurement.

The transmittance spectra of a control sample (WO₃ only, no TaOₓ coating; bottom trace and bottom image), a sample with a 1 nm TaOₓ coating applied by ALD (second from bottom trace), and a sample with a 2 nm TaOₓ coating applied by ALD (third from bottom trace; middle image) after 3 hours of intense UV irradiation are shown in FIG. 11. A bleached (non-darkened) sample is also shown for comparison (top trace; top image; FIG. 11). The photos and spectra show that the 2 nm TaOₓ coating largely prevented any darkening, even under intense, direct exposure to UV irradiation (FIG. 11). The samples were tested with a layer of liquid electrolyte in contact with the inorganic film under the equivalent of 1 sun direct illumination with UV light, as described above.

The transmittance of the TaOₓ coated WO₃ electrode under various conditions is shown in FIG. 15. The results indicate that the TaOₓ coated WO₃ electrode can operate effectively as an electrochromic film by switching between highly transparent and dark coloration, with an intermediate state that selectively blocks primarily NIR light.

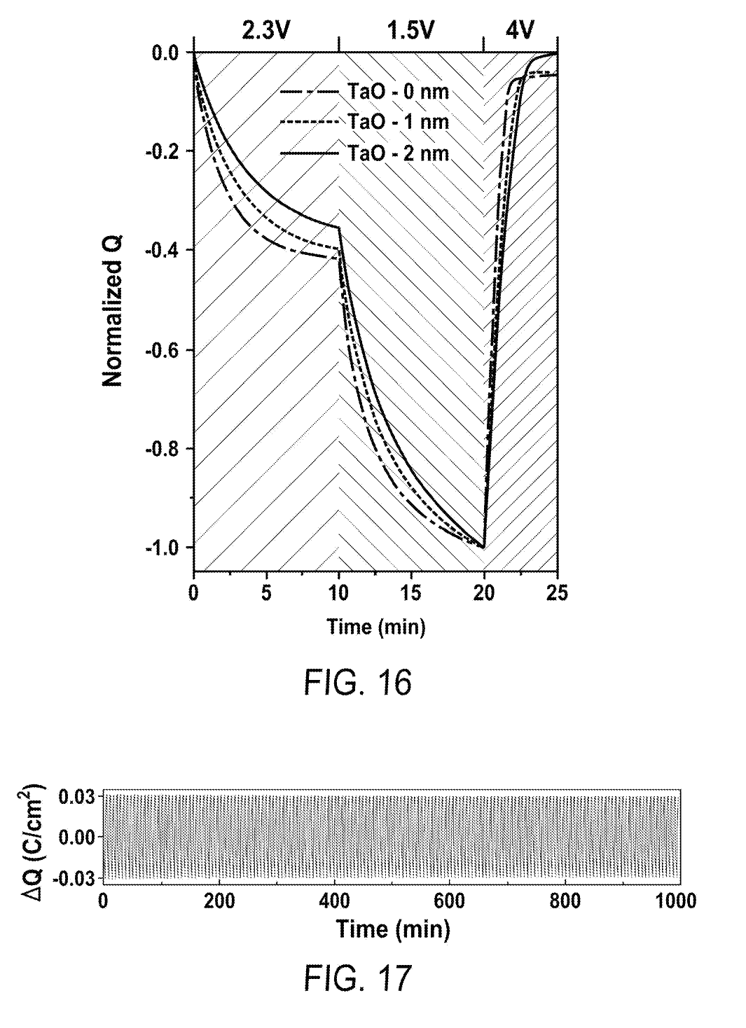

The chronoamperometry kinetics of the electrodes with various thicknesses of TaOₓ coatings are shown in FIG. 16. The results indicate that the switching speed of the TaOₓ coated WO₃ electrode is only modestly reduced by the TaOₓ coatings.

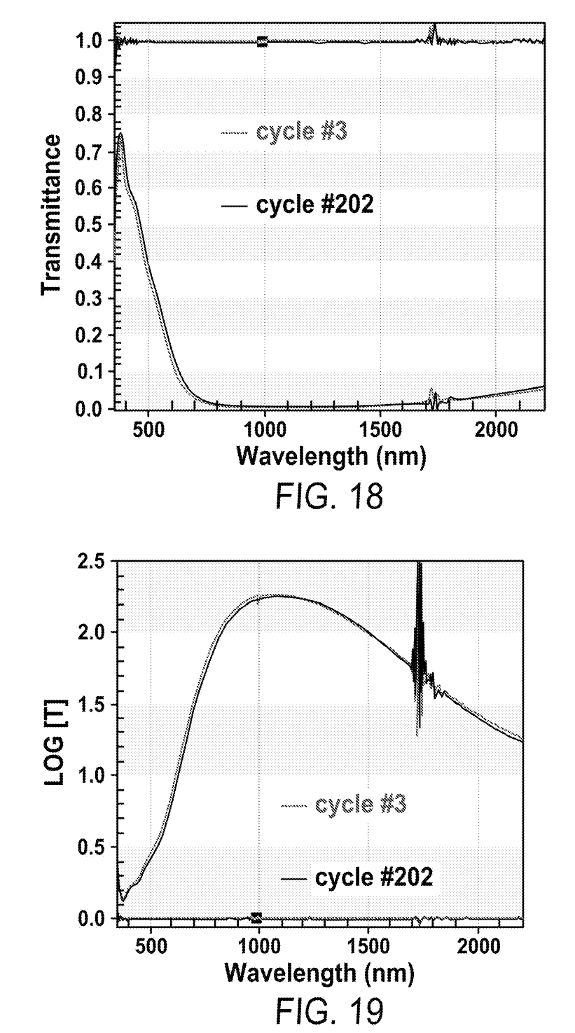

The switching speed over 200 cycles for the TaOₓ coated WO₃ electrode is shown in FIG. 17. The results indicate that the cycling stability is excellent, and is even improved by the TaOₓ coating. The excellent cycling stability is further confirmed by the similarity in the transmittance and absorbance of the TaOₓ coated WO₃ electrode after 3 switching cycles and after 202 switching cycles (FIG. 18 and FIG. 19, respectively).

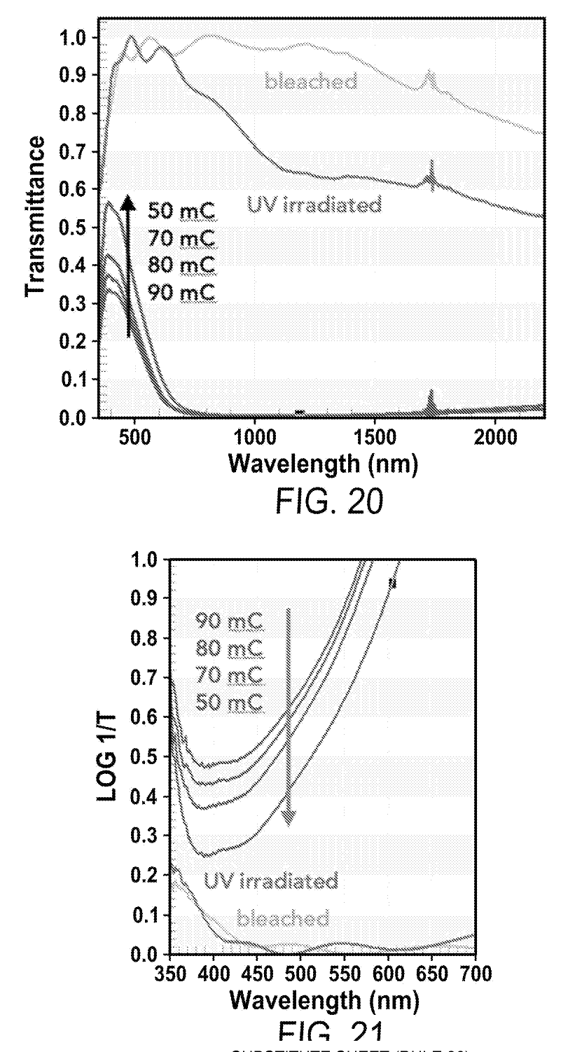

The transmittance and absorbance of the TaOₓ coated WO₃ electrode under various charge conditions are shown in FIG. 20 and FIG. 21, respectively. The results indicate that the electrochromic darkening in the visible range includes some contribution from the TaOₓ, which increases the darkness as more charge is added to the film under applied voltage.

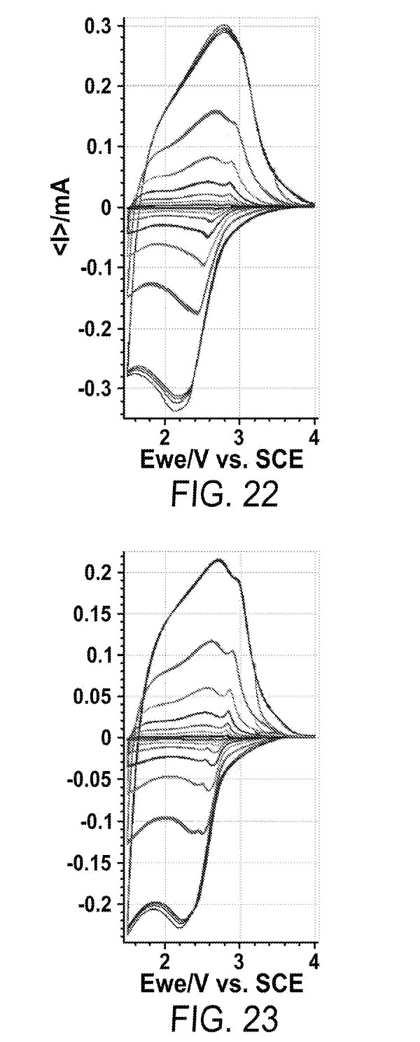

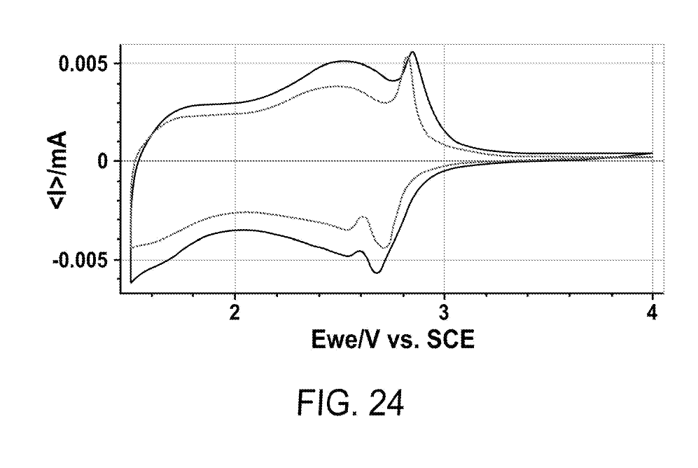

The cyclic voltammograms of the WO₃ film (no Ta₂O₅ coating) and of the TaOₓ coated WO₃ electrode are shown in FIG. 22 and FIG. 23, respectively. An overlay of a cyclic voltammogram of the bare WO₃ film and the TaOₓ coated WO₃ electrode (FIG. 24) shows that the general characteristics of the charging of the electrodes are similar, showing that TaOₓ efficiently transports the Li⁺ in and out of the WO₃ film.

The methods and compositions of the appended claims are not limited in scope by the specific methods and compositions described herein, which are intended as illustrations of a few aspects of the claims and any methods and compositions that are functionally equivalent are within the scope of this disclosure. Various modifications of the methods and compositions in addition to those shown and described herein are intended to fall within the scope of the appended claims. Further, while only certain representative methods, compositions, and aspects of these methods and compositions are specifically described, other methods and compositions and combinations of various features of the methods and compositions are intended to fall within the scope of the appended claims, even if not specifically recited. Thus a combination of steps, elements, components, or constituents can be explicitly mentioned herein; however, all other combinations of steps, elements, components, and constituents are included, even though not explicitly stated.

1. An electrochromic electrode comprising
a conducting layer;
an electrochromic layer; and
a conformal hole blocking layer;
wherein the electrochromic layer is disposed between the conducting layer and the hole blocking layer such that the electrochromic layer is in electrical contact with the conducting layer and the hole blocking layer.

2. The electrochromic electrode of claim 1, wherein the hole blocking layer comprises a metal oxide.

3. (canceled)

4. (canceled)

5. The electrochromic electrode of claim 1, wherein the hole blocking layer comprises Ta₂O₅, Al₂O₃, Nb₂O₅, HfO₂, or combinations thereof.

6. The electrochromic electrode of claim 1, wherein the hole blocking layer has an average thickness of from 0.5 nm to 10 nm.

7. (canceled)

8. The electrochromic electrode of claim 1, wherein the electrochromic layer comprises a metal oxide.

9. (canceled)

10. (canceled)

11. The electrochromic electrode of claim 1, wherein the electrochromic layer comprises WO₃, MoO₃, V₂O₅, Nb₂O₅, TiO₂, Cr₂O₃, MnO₂, CoO, NiO, or combinations thereof.

12. The electrochromic electrode of claim 1, wherein the electrochromic layer comprises a plurality of nanocrystals, a plurality of nanoparticles, or a combination thereof.

13. The electrochromic electrode of claim 12, wherein the plurality of nanocrystals, the plurality of nanoparticles, or a combination thereof have an average particle size of from 1 nm to 1000 nm.

14. The electrochromic electrode of claim 1, wherein the conducting layer comprises a transparent conducting oxide, a carbon material, a nanostructured metal, or a combination thereof.

15. The electrochromic electrode of claim 1, wherein the conducting layer comprises a metal oxide.

16. (canceled)

17. The electrochromic electrode of claim 1, wherein the conducting layer comprises CdO, CdIn₂O₄, Cd₂SnO₄, Cr₂O₃, CuCrO₂, CuO₂, Ga₂O₃, In₂O₃, NiO, SnO₂, TiO₂, ZnGa₂O₄, ZnO, InZnO, InGaZnO, InGaO, ZnSnO, Zn₂SnO₄, CdSnO, WO₃, or combinations thereof.

18. (canceled)

19. The electrochromic electrode of claim 1, wherein the electrochromic electrode has an average transmittance of 50% or more at one or more wavelengths from 400 nm to 2200 nm after irradiation with UV light for 3 hours or more.

20. The electrochromic electrode of claim 1, wherein the electrochromic electrode has a first optical state and a second optical state, wherein each of the first optical state and the second optical state has an average transmittance at one or more wavelengths from 400 nm to 2200 nm, wherein the average transmittance of the second optical state is less than the average transmittance of the first optical state by 20% or more at one or more wavelengths from 400 nm to 2200 nm, and wherein the electrochromic electrode can be switched from the first optical state to the second optical state and/or from the second optical state to the first optical state upon application of a potential to the electrochromic electrode.

21. The electrochromic electrode of claim 1, wherein the electrochromic electrode has a charge capacity that decreases by 5% or less after 200 cycles or more.

22. The electrochromic electrode of claim 1, wherein the electrochromic electrode has an average absorbance at one or more wavelengths from 400 nm to 2200 nm that decreases by 5% or less after 200 cycles or more.

23. The electrochromic electrode of claim 1, wherein the electrochromic electrode has a reduced photochromic effect as compared to an electrode comprising the same conducting layer and electrochromic layer but without the conformal hole blocking layer.

24. A method of making the electrochromic electrode of claim 1, the method comprising:
providing a precursor electrode, the precursor electrode comprising the conducting layer and the electrochromic layer; and
depositing the hole blocking layer conformally on the electrochromic layer of the precursor electrode; thereby forming the electrochromic electrode.

25. The method of claim 24, wherein conformally depositing the hole blocking layer comprises atomic layer deposition, chemical vapor deposition, electron beam evaporation, thermal evaporation, sputtering deposition, pulsed laser deposition, electrodeposition, or combinations thereof.

26.-33. (canceled)

34. An electrochromic device comprising:
the electrochromic electrode of claim 1;
an electrolyte; and
a counter electrode;
wherein the electrochromic electrode of and the counter electrode are in electrochemical contact with the electrolyte.

35. (canceled)

36. A method of use of the electrochromic electrode of claim 1, the method comprising using the electrochromic electrode in a touch panel, an electronic display, a smart window, a transistor, or a combination thereof.
